(19) United States
(12) Patent Application Publication
(10) Pub. No.: US 2016/0284244 A1
(43) Pub. Date: Sep. 29, 2016

(54) SIMULATED ORGAN

(71) Applicant: SEIKO EPSON CORPORATION, Tokyo (JP)

(72) Inventors: Hirokazu SEKINO, Chino-shi (JP); Takeshi SETO, Chofu-shi (JP); Jiro ITO, Hokuto-shi (JP)

(21) Appl. No.: 15/077,842

(22) Filed: Mar. 22, 2016

(30) Foreign Application Priority Data
Mar. 23, 2015 (JP) 2015-059280

(51) Int. Cl. G09B 23/30; G09B 9/00

(52) U.S. Cl. CPC G09B 23/303; G09B 9/00

(57) ABSTRACT

A simulated organ includes a simulated blood vessel in which light is discharged from a damaged site.

### BACKGROUND

1. Technical Field

The present invention relates to a simulated organ.

2. Related Art

A simulated tissue (soft tissue incision practice model) which, when incised, leaks simulated blood from an incision wound so as to enable realistic experience in practice operations and which enables practicing blood removal and hemostasis necessary when bleeding has occurred, is known (Japanese Utility Model Registration No. 3,184,695).

In the related-art technique, since simulated blood is contained in a simulated blood vessel, handling of the simulated blood, which is a liquid, is troublesome.

### SUMMARY

An advantage of some aspects of the invention is that whether a simulated blood vessel is damaged or not can be shown comprehensibly without using simulated blood.

The invention can be implemented in the following forms.

(1) An aspect of the invention provides a simulated organ. The simulated organ includes: a hollow simulated blood vessel; and an inner layer member which has at least a part of an outer peripheral surface surrounded by the simulated blood vessel and which is adapted for discharging light outside via a damaged site of the simulated blood vessel. According to this configuration, the damaged site of the simulated blood vessel can be shown to the user without using a liquid.

(2) In the aspect, the inner layer member may be an optical fiber and may discharge light incident from an end part. According to this configuration, the inner layer member itself need not emit light.

(3) In the aspect, the inner layer member may be hollow. According to this configuration, light can be transmitted utilizing the hollow part.

(4) In the aspect, the inner layer member may have a slit for discharging light. According to this configuration, the wall of the inner layer member need not be formed by a light-transmissive member.

(5) In the aspect, the simulated blood vessel may be curved. According to this configuration, a curved blood vessel can be reproduced.

(6) In the aspect, the simulated organ may further include a simulated tissue filling peripheries of the simulated blood vessel, and the simulated tissue may be excised by a liquid provided with an excision capability. According to this configuration, the simulated organ can be used in a surgical simulation using a liquid provided with an excision capability.

The invention can also be implemented in various other forms. For example, the invention can be implemented as a method for preparing a simulated organ.

### BRIEF DESCRIPTION OF THE DRAWINGS

The invention will be described with reference to the accompanying drawings, wherein like numbers reference like elements.

FIG. 1 shows the schematic configuration of a liquid ejection device.

FIG. 2 is a cross-sectional view showing a simulated organ.

FIG. 3 is a perspective view showing an inner layer member.

FIG. 4 is a flowchart showing a method for preparing a simulated organ.

FIG. 5 shows how a strength test on the material of the inner layer member is conducted.

FIG. 6 is a graph showing experiment data obtained by the strength test.

FIG. 7 is a cross-sectional view taken along 7-7 in FIG. 2.

FIG. 8 is a cross-sectional view showing a simulated organ (modification).

### DESCRIPTION OF EXEMPLARY EMBODIMENTS

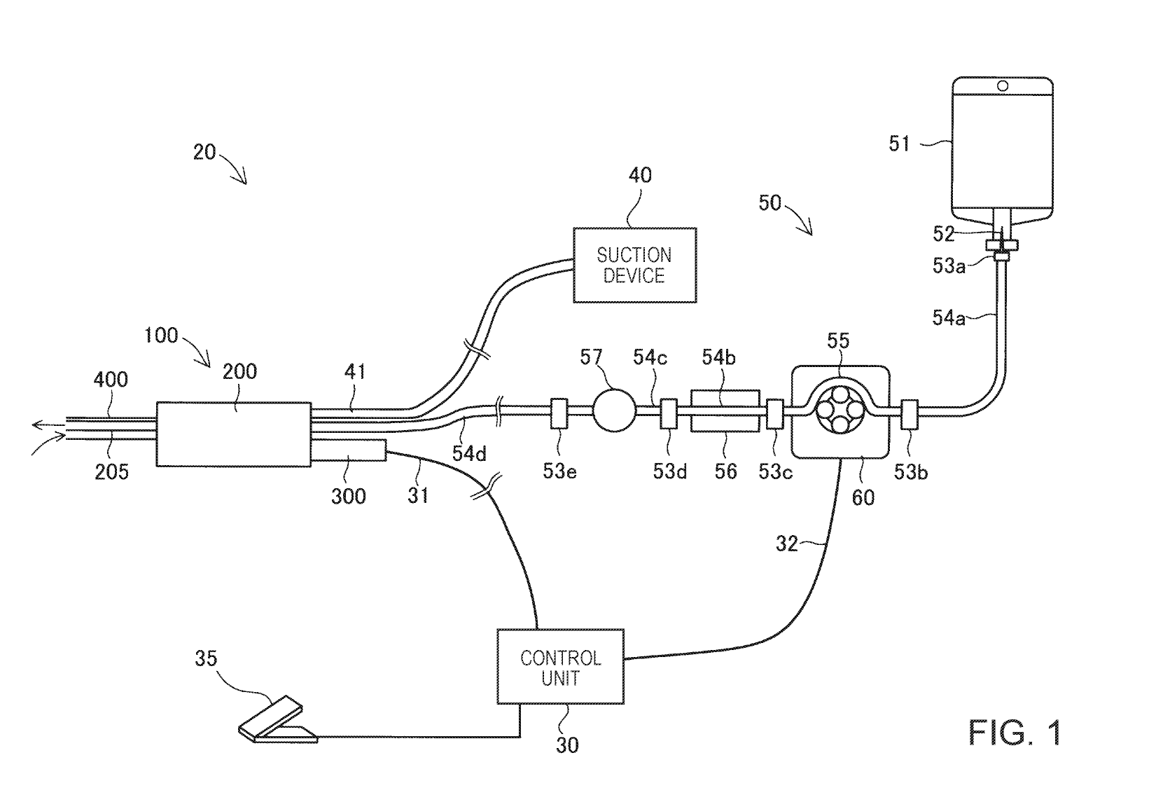

FIG. 1 schematically shows the configuration of a liquid ejection device 20. The liquid ejection device 20 is a medical device used in a medical institution and has the function of excising an affected part by ejecting a liquid to the affected part.

The liquid ejection device 20 has a control unit 30, an actuator cable 31, a pump cable 32, a foot switch 35, a suction device 40, a suction tube 41, a liquid supply device 50, and a handpiece 100.

The liquid supply device 50 has a water supply bag 51, a spike 52, first to fifth connectors 53a to 53e, first to fourth water supply tubes 54a to 54d, a pump tube 55, a blocking detection mechanism 56, and a filter 57. The handpiece 100 has a nozzle unit 200 and an actuator unit 300. The nozzle unit 200 has an ejection tube 205 and a suction tube 400.

The water supply bag 51 is made of a transparent synthetic resin and its inside is filled with a liquid (specifically, physiological saline solution). In this description, this bag is called the water supply bag 51 even if it is filled with a liquid other than water. The spike 52 is connected to the first water supply tube 54a via the first connector 53a. As the spike 52 stings the water supply bag 51, the liquid filling the water supply bag 51 becomes available to be supplied to the first water supply tube 54a.

The first water supply tube 54a is connected to the pump tube 55 via the second connector 53b. The pump tube 55 is connected to the second water supply tube 54b via the third connector 53c. A tube pump 60 has the pump tube 55 inserted therein. The tube pump 60 feeds the liquid inside the pump tube 55 from the side of the first water supply tube 54a toward the second water supply tube 54b.

The blocking detection mechanism 56 measures the pressure inside the second water supply tube 54b and thereby detects blocking inside the first to fourth water supply tubes 54a to 54d.

The second water supply tube 54b is connected to the third water supply tube 54c via the fourth connector 53d. To the third water supply tube 54c, the filter 57 is connected. The filter 57 collects foreign matters contained in the liquid.

The third water supply tube 54c is connected to the fourth water supply tube 54d via the fifth connector 53e. The fourth water supply tube 54d is connected to the nozzle unit 200. The liquid supplied through the fourth water supply tube 54d is intermittently ejected from the tip of the ejection tube 205 by the driving of the actuator unit 300. As the liquid is thus ejected intermittently, an excision capability can be secured with a low flow rate.

The ejection tube 205 and the suction tube 400 form a double-tube structure with the ejection tube 205 being the inner tube and the suction tube 400 being the outer tube. The suction tube 41 is connected to the nozzle unit 200. The suction device 40 sucks the content inside the suction tube 400 through the suction tube 41. By this suction, the liquid and excised piece or the like near the tip of the suction tube 400 are sucked.

The control unit 30 controls the tube pump 60 and the actuator unit 300. Specifically, the control unit 30 transmits drive signals via the actuator cable 31 and the pump cable 32 while the foot switch 35 is pressed down with a foot. The drive signal transmitted via the actuator cable 31 drives a piezoelectric element (not illustrated) included in the actuator unit 300. The drive signal transmitted via the pump cable 32 drives the tube pump 60. Therefore, while the user keeps his or her foot down on the foot switch 35, the liquid is intermittently ejected. When the user does not keep his or her foot down on the foot switch 35, the ejection of the liquid stops.

A simulated organ will be described hereafter. A simulated organ is also called a phantom. In this embodiment, a simulated organ is an artificial object whose part is to be excised by the liquid ejection device 20. The simulated organ in this embodiment is used in a surgical simulation for the purpose of performance evaluation of the liquid ejection device 20, practice of operation of the liquid ejection device 20, and the like.

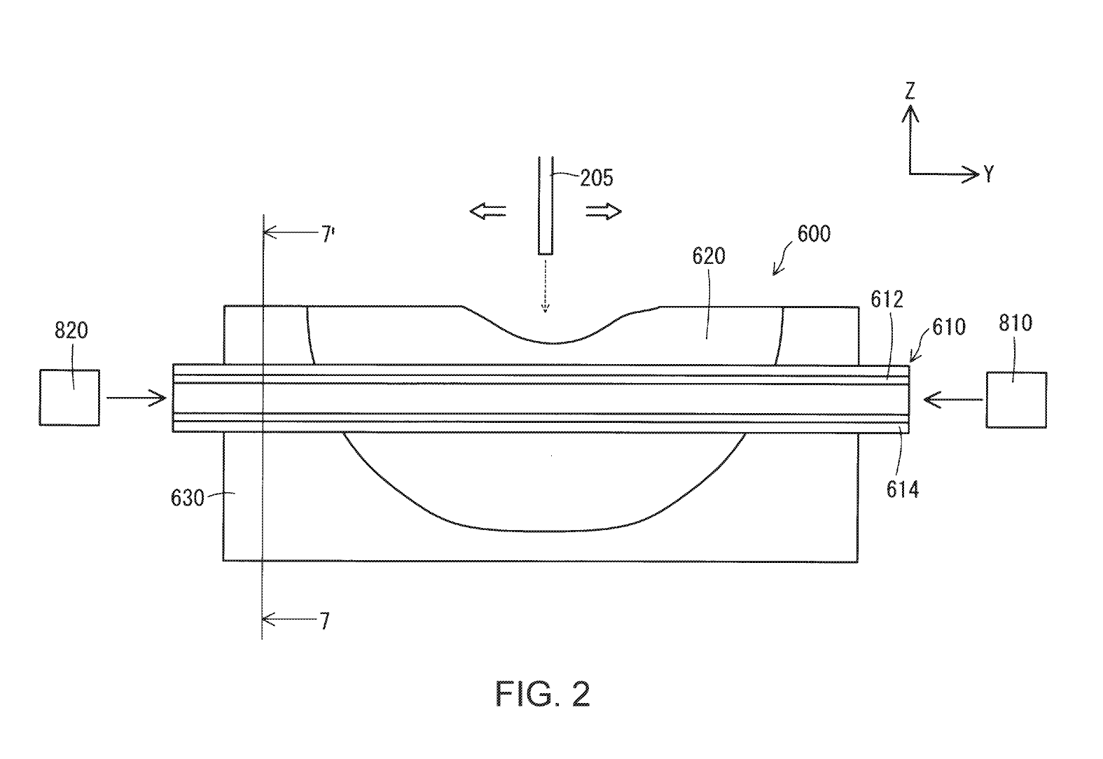

FIG. 2 is a cross-sectional view showing a simulated organ 600. The cross section shown in FIG. 2 is a Y-Z plane. In this embodiment, the horizontal plane is defined as an X-Y plane, and the vertical direction (direction of depth) is defined as a Z-direction. The simulated organ 600 includes an embedded member 610, a simulated tissue 620, and a support member 630.

The embedded member 610 has a double structure in which a simulated blood vessel 614 surrounds the outside of an inner layer member 612. It can also be said that the inner layer member 612 is arranged inside the simulated blood vessel 614. The inner layer member 612 in this embodiment is formed by a hollow optical fiber for visible light and has an inner diameter of 0.5 mm and a transmission efficiency of 30 to 65%.

The simulated blood vessel 614 is formed of a material simulating a blood vessel in a living body. The simulated blood vessel 614 is an artificial object simulating a blood vessel in a living body (for example, human cerebral blood vessel) and is a member that should avoid damage in a surgical simulation.

The simulated tissue 620 is an object simulating peripheral tissues around a blood vessel in a living body (for example, brain tissues) and fills the peripheries of the simulated blood vessel 614. The support member 630 is a metallic container which supports the embedded member 610 and the simulated tissue 620.

The liquid ejected intermittently from the ejection tube 205 gradually excises the simulated tissue 620. As the excision proceeds, the simulated blood vessel 614 becomes exposed. The exposed simulated blood vessel 614 may be subjected to the liquid ejection in some cases. The simulated blood vessel 614 becomes damaged when subjected to the ejection under conditions exceeding its strength. The damage here refers to the formation of a penetration hole in the wall of the simulated blood vessel 614.

As shown in FIG. 2, light sources 810, 820 are installed by the side of the simulated organ 600. The light sources 810, 820 emit light with an LED. The emitted light becomes incident on the inside of the inner layer member 612 from both ends of the inner layer member 612 and is transmitted through the inside of the inner layer member 612. In FIG. 2, the light sources 810, 820 are illustrated as being spaced apart from the end parts of the embedded member 610. However, in practice, the light sources 810, 820 are arranged in contact with the end parts of the embedded member 610. This arrangement enhances the efficiency of incidence of the light.

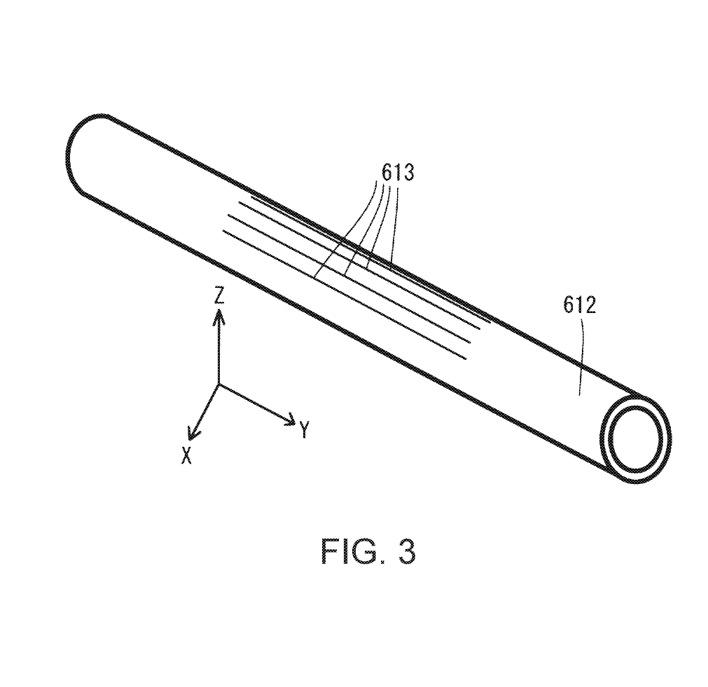

FIG. 3 is a perspective view showing the inner layer member 612. A plurality of slits 613 is provided on the inner layer member 612, as shown in FIG. 3. The slits 613 penetrate the tube wall of the inner layer member 612. Therefore, the light transmitted through the inside of the inner layer member 612 is discharged from the slits 613.

If the simulated blood vessel 614 is damaged as described above, the light transmitted through the inside of the inner layer member 612 is discharged from the damaged site via the slits 613. The user can grasp that the simulated blood vessel 614 has been damaged, and the damaged site, by visually recognizing the light discharged from the damaged site. If a method using light is available in this way, handling and preservation become easier than in the case of a method using a liquid.

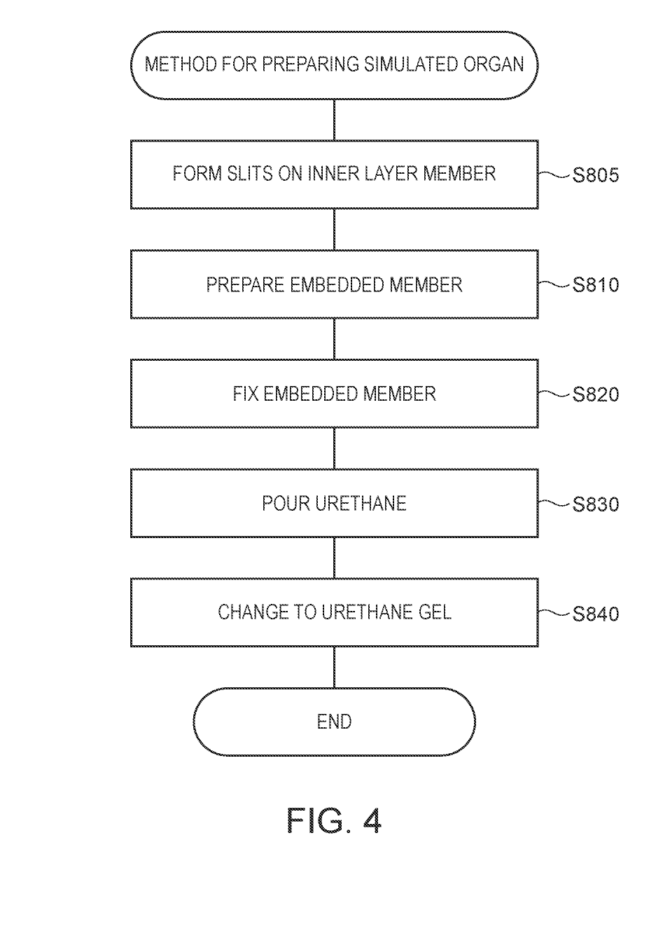

FIG. 4 is a flowchart showing a method for preparing the simulated organ 600. First, the slits 613 are formed on the inner layer member 612 (S805). S805 is carried out, for example, by a person using a cutting tool.

Next, the embedded member 610 is prepared (S810). That is, the simulated blood vessel 614 is formed on the outer circumferential surface of the inner layer member 612 provided with the slits 613. Specifically, the material of the simulated blood vessel 614 before hardening is applied to the outer circumference of the inner layer member 612 with a paintbrush, and then hardened. The embedded member 610 is thus formed.

In this embodiment, PVA (polyvinyl alcohol) is employed as the material of the simulated blood vessel 614. As already known, PVA can be changed in strength by changing preparation conditions.

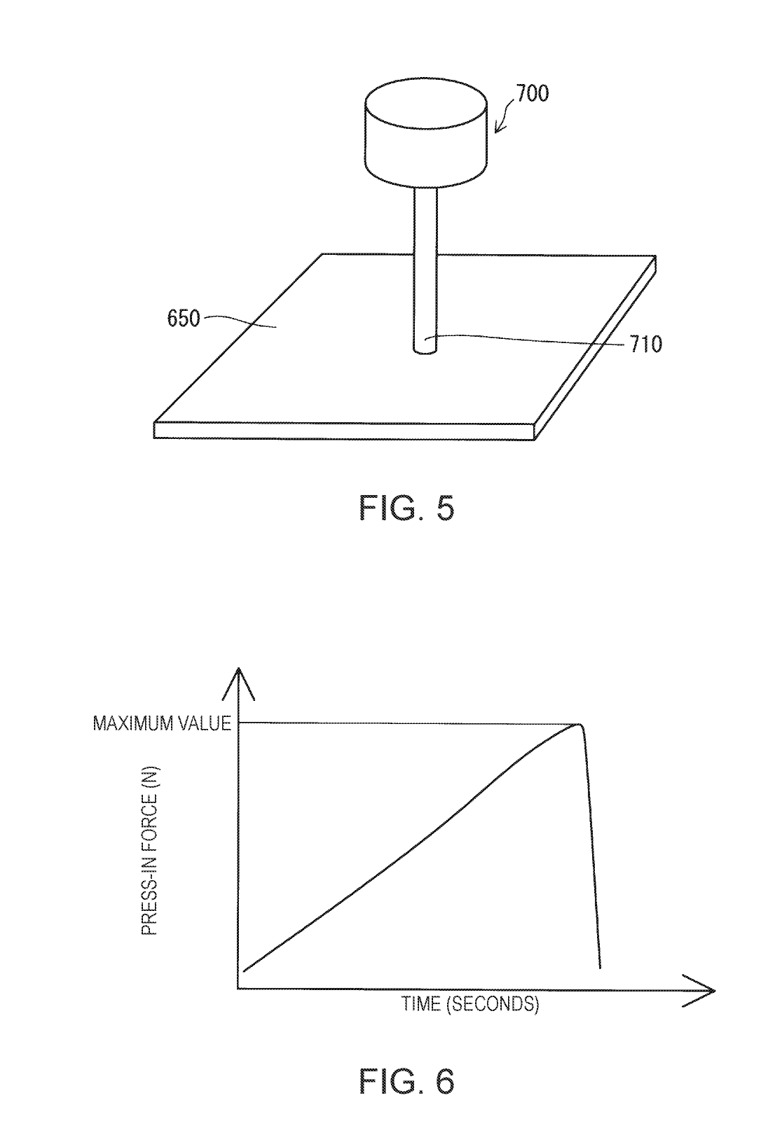

FIG. 5 is a view for explaining a strength test on a material. A sheet 650 is a test sample formed by shaping the material of the simulated blood vessel 614 into a sheet. The sheet 650 is placed on a table (not illustrated) and fixed to the table at its peripheral edges. The table has a hole opening at a position opposite to a pin 700 via the sheet 650. In the strength test, the pin 700 is pressed into the sheet 650 so as to deform the sheet 650 until the sheet 650 breaks. A load cell (not illustrated) is used to press in the pin 700, and the press-in force is measured in real time.

FIG. 6 shows an example of experiment data obtained from the strength test. The vertical axis represents press-in force. The horizontal axis represents time. The pressing of the pin 700 is carried out at 1 mm/sec. Therefore, the press-in force increases almost linearly with time, as shown in FIG. 6.

The press-in force increases in this manner and eventually drops sharply. The sharp drop in the press-in force occurs because of the breaking of the sheet 650. Based on the sharp drop in the press-in force, the maximum value of the press-in force can be decided. The material strength is acquired as a stress value (MPa) by dividing the maximum value (N) of the press-in force by the area of a tip 710 of the pin 700 (in this embodiment, 0.5 mm²).

By this test, the material of the simulated blood vessel 614 is prepared in such a way as to have a strength close to the strength of the blood vessel to be reproduced. Using the material thus prepared, the simulated blood vessel 614 is produced.

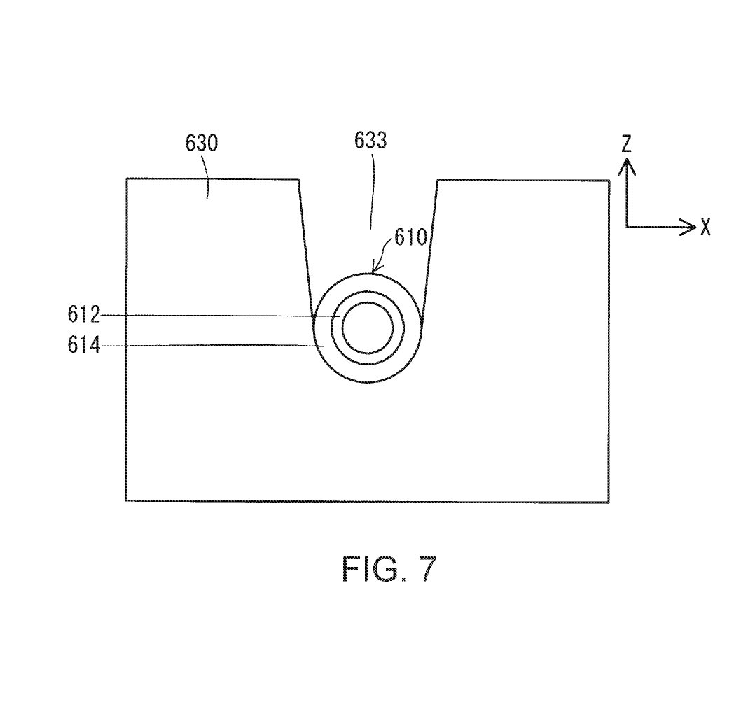

Next, the embedded member 610 is fixed to the support member 630 (S820). FIG. 7 shows a cross section taken along 7-7 in FIG. 2 (Z-X plane) and shows the state where S820 has been executed.

As shown in FIG. 7, a groove 633 is provided in the support member 630. The embedded member 610 is fitted into the groove 633 in S820 and thus fixed to the support member 630.

Next, a stirred mixture of a base resin of urethane and a hardener is poured into the support member 630 (S830). Subsequently, the urethane changes into a urethane gel in the form of an elastomer gel (S840). Thus, the simulated tissue 620 is formed and the simulated organ 600 is completed.

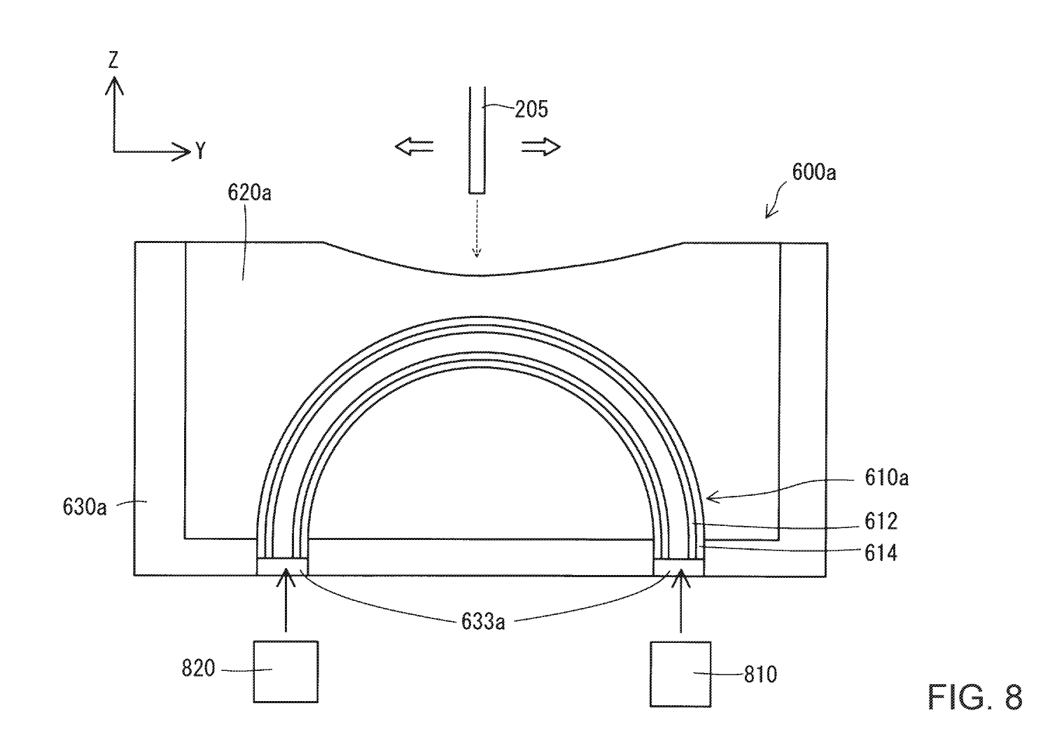

A modification will be described below. FIG. 8 is a cross-sectional view showing a simulated organ 600a. The simulated organ 600a includes an embedded member 610a, a simulated tissue 620a, and a support member 630a.

As shown in FIG. 8, the embedded member 610a is curved. That is, the embedded member 610a has its both ends fixed to the bottom surface of the support member 630a and is in an arc shape. The embedded member 610a has a double structure including an inner layer member 612 and a simulated blood vessel 614, similarly to the embedded member 610 in the embodiment.

As described above, the inner layer member 612 is formed by a hollow optical fiber for visible light and the simulated blood vessel 614 is made of PVA. Therefore, the embedded member 610a is flexible.

The support member 630a has penetration holes 633a for fixing both ends of the embedded member 610a. Light sources 810, 820 cast light to the end parts of the embedded member 610a via the penetration holes 633a.

In this way, the embedded member 610a can be formed in a curved shape as well as in a straight line. Therefore, a curved site of a blood vessel in a living body can be reproduced with conditions closer to those of the living body.

The invention is not limited to the embodiment, examples and modifications in this specification and can be implemented with various configurations without departing from the scope of the invention. For example, technical features described in the embodiment, examples and modifications corresponding to technical features of each configuration described in the summary of the invention can be replaced or combined according to need, in order to solve a part or all of the foregoing problems or in order to achieve apart or all of the advantageous effects. Technical features can be deleted according to need, unless described as essential in the specification. For example, the following examples can be employed.

The simulated organ may be excised by measures other than a liquid that is intermittently ejected. For example, the simulated organ may be excised by a liquid that is continuously ejected or by a liquid provided with an excision capability by ultrasonic waves or a metal scalpel. Alternatively, the simulated organ may be excised by a metallic surgical knife.

The number of the simulated blood vessels may be any number equal to or greater than two.

The material of the simulated blood vessel is not limited to the above example. For example, the material may be a synthetic resin other than PVA (for example, urethane) or may be a natural resin.

The material of the simulated tissue is not limited to the above example. For example, the material may be a rubber-based material other than urethane or may be PVA.

The simulated blood vessel may be prepared using ejection and deposition (3D printing by an inkjet method or the like).

The simulated tissue may be prepared using 3D printing.

The simulated blood vessel and the simulated tissue may be collectively prepared using 3D printing.

The simulated blood vessel may be prepared by depositing PVA on the inner layer member, using 3D printing.

The simulated blood vessel may be prepared by spraying a material which is to form the simulated blood vessel onto the inner layer member with a sprayer or the like.

The simulated blood vessel may be prepared by filling a tank with a material which is to form the simulated blood vessel, soaking the inner layer member therein, and then lifting the inner layer member up.

Alternatively, the embedded member may be prepared by covering the inner layer member with the simulated blood vessel formed in a hollow shape. As a method for forming the simulated blood vessel as a hollow member, for example, PVA before hardening is applied to the outer circumference of an extra fine wire, and the extra fine wire is pulled out after the hardening of the PVA. The outer diameter of the extra fine wire is made to correspond to the outer diameter of the inner layer member. The extra fine wire is made of metal (piano wire or the like), for example.

The shape in which the embedded member is embedded is not limited to the illustrated example. For example, the embedded member may be bent into an S-shape or may be bent within the horizontal plane (X-Y plane).

The inner layer member may be formed by a member other than the hollow optical fiber for visible light. For example, the inner layer member may be formed by a light guide rod in the form of a hollow member or solid member. The light guide rod may be made of plastics, for example. Specifically, the light guide rod may be made of a polyurethane resin.

When light becomes incident on the light guide rod from the ends, its entire outer circumferential surface emits light. Therefore, slits need not be provided on the outer circumferential surface.

In the case of providing slits on the inner layer member (optical fiber or light guide rod) as a solid member, since there is no hollow part to penetrate into, the slits may be provided as grooves.

In the case of providing slits on the light guide rod as a hollow member, the slits may be provided as grooves without penetrating into the hollow part.

The inner layer member need not be flexible. For example, if the inner layer member is prepared with pure quartz, the inner layer member has no flexibility. In this case, the embedded member may be arranged in the shape of a straight line.

The inner layer member itself may emit light. For example, a light emitting element may be arranged inside the inner layer member.

The inner layer member need not be a rod-like member. For example, a plurality of light emitting elements may be arranged, spaced apart from each other, in the hollow part of the simulated blood vessel.

The light emission by the light source need not use an LED and may use a halogen lamp or xenon lamp, for example.

Only one light source may suffice. That is, light may be made incident simply from one end part of the embedded member.

The arrangement of the light source may be changed by bending the end parts of the inner layer member with flexibility.

While the configuration in which the entire outer circumferential surface of the inner layer member 612 is surrounded by the simulated blood vessel 614 is employed above, this is not limiting. A configuration in which the simulated blood vessel 614 covers a part of the outer circumferential surface of the inner layer member 612 may be employed. Apart of the outer circumferential surface of the inner layer member 612 refers to, for example, a part in the circumferential direction of the outer circumferential surface. It suffices that the inner layer member 612 is covered by the simulated blood vessel 614 to such an extent that the user does not visually recognize light when the simulated blood vessel 614 is not damaged in a surgical simulation.

In other words, the inner layer member 612 may have a part arranged inside the simulated blood vessel 614 (unexposed part) and a part exposed outside the simulated blood vessel 614 (exposed part). Also, in order to form such an exposed part, a hole or cut-out may be formed at a part of the simulated blood vessel 614, or the inner layer member 612 may stick out of the simulated blood vessel 614.

While the configuration using the piezoelectric element as the actuator is employed in the embodiment, a configuration in which a liquid is ejected using an optical maser, or a configuration in which a liquid is pressurized by a pump or the like and thus ejected, may be employed. The configuration in which a liquid is ejected using an optical maser refers to the configuration in which a liquid is irradiated with an optical maser to generate air bubbles in the liquid, so that a pressure rise in the liquid caused by the generation of the air bubbles can be utilized.

The entire disclosure of Japanese Patent Application No. 2015-059280 filed Mar. 23, 2015 is expressly incorporated by reference herein

What is claimed is:

1. A simulated organ comprising:
a hollow simulated blood vessel; and
an inner layer member which has at least a part of an outer peripheral surface surrounded by the simulated blood vessel and which is adapted for discharging light outside via a damaged site of the simulated blood vessel.

2. The simulated organ according to claim 1, wherein
the inner layer member is an optical fiber and discharges light incident from an end part.

3. The simulated organ according to claim 1, wherein
the inner layer member is hollow.

4. The simulated organ according to claim 1, wherein
the inner layer member has a slit for discharging light.

5. The simulated organ according to claim 1, wherein
the simulated blood vessel is curved.

6. The simulated organ according to claim 1, further comprising a simulated tissue filling peripheries of the simulated blood vessel,
wherein the simulated tissue is excised by a liquid provided with an excision capability.
